(19) United States
(12) Patent Application Publication
(10) Pub. No.: US 2020/0202454 A1
(43) Pub. Date: Jun. 25, 2020

(54) SYSTEM AND METHOD FOR GRADING SEXUAL INTERACTIONS

(71) Applicant: KING JOSHUA, Boca Raton, FL (US)

(72) Inventor: KING JOSHUA, Boca Raton, FL (US)

(21) Appl. No.: 16/225,357

(22) Filed: Dec. 19, 2018

(51) Int. Cl. G06Q 50/00; G06F 16/9538

(52) U.S. Cl. CPC G06Q 50/01; G06F 16/9538

(57) ABSTRACT

A system and method for confirming the details of a user's sexual history; evaluating and assigning grades to a user's performance of sexual interactions, ranking users based on any combination of geographical location and/or any part, total or average of the grades; providing scientific research, news and tips to improve the performance of sexual interactions via multi-medias, based on evaluations, grades, rankings and/or other scientific research; reporting a sex crime based on scientific research and the results of the evaluations, if nonconsensual sexual interactions are alleged; sharing and embedding grades and/or rankings on social medias, websites or mobile applications; setting a future time and place, giving consent or not for any part or whole of a date or sexual interaction, based on grades, rankings and/or scientific research; match-making or pairing users for a date or sexual interaction, based on grades, rankings and/or scientific research; geographically searching for and locating users for a date or sexual interaction, based on grades, rankings and/or scientific research and; customizing merchandise to be manufactured and purchased, customized based on grades, rankings, scientific research and/or location.

### FIELD OF THE INVENTION

Briefly, one embodiment of the present invention relates to technology or software, more particularly but not exclusively, an online system and method for evaluating, grading, ranking and providing research, news and tips to improve a user's performance of sexual interactions.

### BACKGROUND OF THE INVENTION

Sexual intercourse, historically, has been a sensitive subject for public discussion. Recently, however, sexual improprieties have been broadcasted and promulgated on social medias, websites, mobile applications and other online publications. Despite these revelations, there is still mass miscommunication, miseducation and misinformation regarding sexual interactions, performance of sexual interactions and all other sexual subjects. More specifically, most of the social medias, websites, etc. that have been used to discuss these issues, were not explicitly created to address all topics related to sexual intercourse.

Pre-empting the recent public outcry, a company was proactively started by the inventor to specifically address and improve the understanding and performance of the issues and interactions regarding sexual intercourse.

### BRIEF DESCRIPTION OF THE DRAWINGS

Non-limiting and non-exhaustive embodiments of the present invention are described with reference to the following drawings. In the drawings, like reference numbers refer to like parts throughout the various figures unless otherwise noted.

For a better understanding of the present invention, reference will be made to the following Detailed Description of the Invention, which is to be read in association with the accompanying drawings herein:

FIG. 1 shows a functional block diagram illustrating one embodiment of an environment practicing the invention;

FIG. 2 shows a client-server network model illustrating one embodiment that may be included in a system implementing the invention;

FIG. 3 shows a peer-to-peer network model illustrating one embodiment that may be included in a system implementing the invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the terms “or” and “and” are inclusive “or” and “and” operator and are equivalent to the term “and/or,” unless the context clearly dictates otherwise. The term “based on” is not exclusive and allows for being based on additional factors not described. In addition, throughout the specification, the meaning of “a,” “an,” and “the” include plural references. The meaning of “in” includes “in” and “on”. “Sexual partner” refers to, but is herein no way exclusive to mean, participants, alleged or confirmed, of a sexual interaction. The term “sexual interaction” is not exclusive and can include additional meanings not herein but generally means flirting, kissing, foreplay, oral sex, sexual intercourse, and afterwards. “Sexual history” briefly refers to previously occurring sexual interactions. The term “flirting” generally refers to, but is not exclusive to mean, the verbal or nonverbal communication or behavior that is amorous yet superficial and without serious intent. “Kissing”, as used herein, but not exclusively, means to touch with the lips as a sign of affection. “Foreplay” is the equivalent of erotic stimulation that proceeds sexual intercourse but is not exclusive to that meaning. “Oral sex” means, unless clearly stated or context suggests otherwise, the oral stimulation of the genitals. “Sexual intercourse” not exclusively mean coitus, anal intercourse and any other penetrative or non-penetrative intercourse between LGBTQ users. “Afterwards” is not exclusive to the meaning herein but generally refers to the actions that take place post flirting, kissing, foreplay, oral sex or sexual intercourse. “LGBTQ” means lesbian, gay, bisexual, transgender and queer, respectively. “Grades” and “Grading” respectively refer to the values assigned (i.e. letter grades, stars, numerals, etc.) and the act of assigning those values, but is not exclusive and can include additional meanings not herein. The term “rank” and “ranking” generally refers to the standing of a user compared to other users based on grades and the act of classifying or ordering users, not exclusively, according to grades and/or the evaluation results. “Match-making” generally refers to making recommendations to others for a date or sexual interaction or the act of bringing two or more people together, i.e. pairing, for a date or sexual interaction but is not exclusive to the meaning herein. “Searching” refers to the employment of the invention software to geographically locate other users particularly but not exclusively based on grades assigned to performance of sexual interactions. “Match”, herein nonexclusively, means a suitable or potential person for a recommendation for a date or sexual interaction, unless noted otherwise. “User” generally and nonexclusively refers to a person employing any given embodiment of the present invention but does not necessarily refer to the same user, though it may. The term “consent”, as used herein, generally but not exclusively means permission or agreement to engage or participate in a sexual interaction. The terms “client-server” and “peer-to-peer”, as used herein, generally but not exclusively refer to methods of internet connectivity.

Briefly stated, one embodiment of the present invention is directed towards an online software system and method for:
Confirming a user's sexual history;
Evaluating and assigning grades to a user's performance of sexual interactions, specifically, but not exclusively;
   Flirting, Kissing, Foreplay, Oral Sex, Sexual Intercourse (including Anal Sex, Pegging and other Sexual Intercourse between LGBTQ users) and After, or the actions and behavior of a user, post flirting, kissing, foreplay, oral sex and/or sexual intercourse;
Ranking users based on any combination of geographical location and/or any part, total or average of the grades;
Providing scientific research, news and tips to improve the performance of sexual interactions via multi-medias, based on evaluations, grades, rankings and/or other scientific research;
Reporting a sex crime based on the results of the evaluations and scientific research, if nonconsensual sexual interactions are alleged by users.
Sharing and embedding grades and/or rankings on social medias, websites or mobile applications;
Setting a future time and place, giving consent or not for any part or whole of a date or sexual interaction, based on grades, rankings and/or scientific research;
Match-making or pairing users for a date or sexual interaction, based on grades, rankings and/or scientific research;
Geographically searching for and locating users for a date or sexual interaction, based on grades, rankings and/or scientific research.
Customizing, manufacturing and selling merchandise, customizations based on grades, rankings scientific research and/or location.

In one embodiment of present invention, users log in or register for membership on the website or mobile application, utilizing client-server and/or peer-to-peer network models for internet connectivity. Then, users enter the contact information (i.e. username, email, phone number, etc.) of a previous sexual partner and details of sexual interactions experienced. Users can also choose to enter the contact information of a desired match for oneself or another user, for match-making purposes, giving consent or not to any potential future dates or sexual interactions. The invention is then employed in sending a message to confirm a previous sexual interaction or time and place for a future date or sexual interaction for oneself or another user for match-making purposes. Once a sexual interaction is experienced by both users and confirmed by the invitee user, both users evaluate and grade each other's, and their own, performance of sexual interactions and are ranked among other users based on total average of grades received. For example, a user receiving an A+ for all sexual interactions (flirting, kissing, foreplay, oral sex, sexual intercourse and after), would receive an average grade of A+ for the total sexual interaction. Grades are averaged or totaled together and are ranked among other users of the invention. Utilizing multi-medias, the invention sends scientific research, tips and news about improving performance of sexual interactions, based on the evaluations, grades and rankings. Based on the results of the evaluations and grades, if a nonconsensual sexual interaction occurred, users can report a sex crime. Users can choose to share or embed their grades and/or rankings on websites, social medias and other online or mobile applications. Once a user confirms an invitation to a future date or sexual interaction, the inviter or the invitee user can give consent or not for any part or total sexual interaction. In one embodiment, users can also employ the invention to geographically search for other users for a potential date or sexual interaction, based on location, evaluation, grades received and ranking. Users can also purchase merchandise that is customized and sold, with customizations based non-exclusively on evaluation results, grades, rankings and/or location. Any one of these features may be used in any variation and the description of an embodiment of the present invention herein is not binding or limiting.

### Illustrative Invention Environment

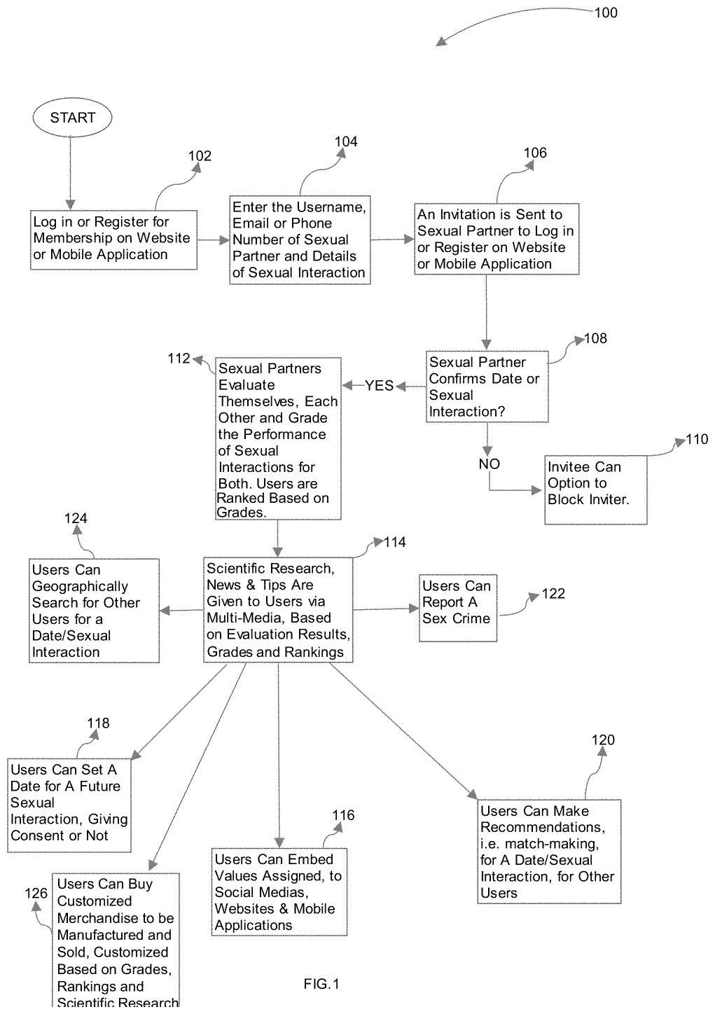

FIG. 1 illustrates a logical flow diagram generally showing one embodiment of a process for an online system and method for evaluating, grading and ranking, setting a future date giving consent or not for, match-making based on, reporting the crime of, searching geographically for others based on, providing scientific research, news and tips about, the performance of sexual interactions. However, not all of these components may be required to practice the invention, and variations in the arrangement and type of the components may be made without departing from the feeling or scope of the invention.

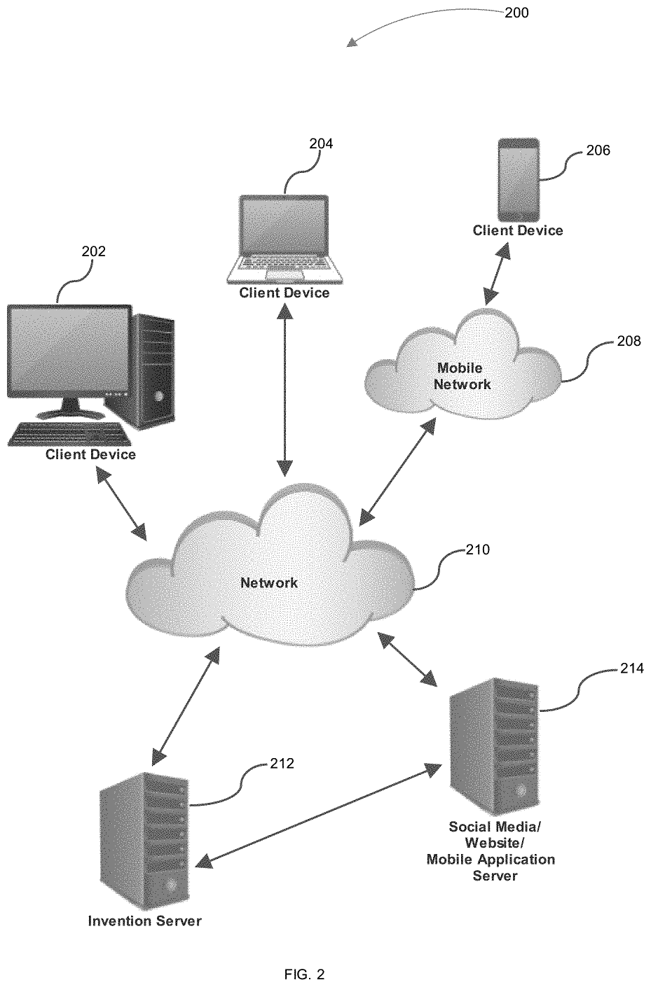

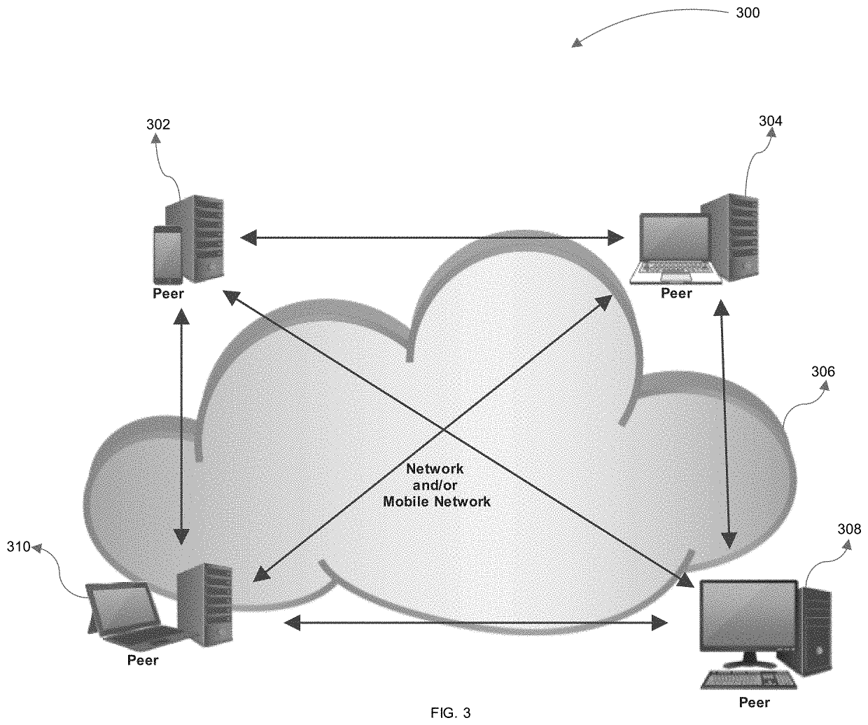

As shown in the figure, process 100 typically begins, after a start block, at block 102, a user typically logs in or registers for a member profile on the website or mobile application, using a device to connect to the internet either using the client server network model or the peer to peer network model in FIG. 2, and FIG. 3, respectively. Proceeding to block 104, users enter the contact information, i.e. username, phone number, email, etc., of previous sexual partners and details of the sexual interaction. At block 106, the invention sends an invitation to the alleged sexual partner. Block 108 shows the choice of whether or not the sexual partner chooses to confirm or deny the purported sexual interaction. In block 110, the invitee user chose to deny the purported sexual interaction and has further options to block the inviter from sending any future invitations to the invitee. At block 112, where after confirming the sexual interaction, users evaluate and grade themselves and each other on the performance of sexual interactions, specifically but not exclusively, flirting, kissing, foreplay, oral sex, sexual intercourse and afterwards. Users are ranked among other users based on geographical location and grades. In block 114, scientific research, news and tips are given to both users based on grades, rankings and other scientific research, in order to improve their performance of sexual interactions. Users can embed the grades and/or rankings on social medias, websites and other online or mobile applications at block 116. At block 118, users can set a future time and place giving consent or not for any part or whole of a date or sexual interaction. In the present figure illustrating process 100, at block 120 users can also utilize the invention for match-making purposes in recommending users for pairing for a date or sexual interaction, based on grades, rankings and/or scientific research. If a user experienced a sexual interaction that was not consensual, in whole or part, that user can employ the invention and report a sex crime at block 122. At block 124, users can geographically search for other users, based on their grades, rankings and/or scientific research. At block 126, users can purchase merchandise that is manufactured, customized, and sold, based on the evaluation results, grades, rankings, scientific research and/or location. It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide one embodiment or description of the manufacture and use of the composition of the invention. It is noted that these are examples of possible elements that may be used to develop the embodiments of the present invention and is in no manner intended to be exhaustive or limiting.

### Illustrative Client-Server Network Environment

FIG. 2. illustrates one embodiment of a client-server environment in which the present invention may operate. However, not all of these components may be required to practice the invention, and variations in the arrangement and type of the components may be made without deviating from the original scope or feeling of the invention.

As shown in the figure, system 200 includes client devices 202, 204 and 206, mobile network 208, network 210, invention server 212 and social media, website or mobile application server 214. Network 210 is in communication with client devices 202, 204, 206 by way of mobile network 208, invention server 212 and social media, website or mobile application server 214.

Generally, client devices 202, 204 and 206 may include virtually any computing device capable of receiving and sending a message over a network, such as network 210, mobile network 208, or the like, to and from another computing device, such as invention server 212, each other, or the like. Client devices may include other applications that are configured to connect to the internet, receive and to send web pages, web-based messages, and the like, configured to receive and display graphics, text, multimedia, and the like, employing virtually any web-based language, including but not limited to Standard Generalized Markup Language (SMGL), HyperText Markup Language (HTML), eXtensible Markup Language (XML), and so forth. The set of such devices may include devices that typically connect to the internet, via network 210 or mobile network 208, using a wired or wireless communications medium such as mobile phones 206, laptops 204, tablets, personal computers 202, multiprocessor systems, microprocessor-based or programmable consumer electronics, network PCs, and the like. As shown in FIG. 2., process 200 illustrates one embodiment of the invention but is not so limited or restricted and may employ other elements not described herein.

### Illustrative Peer-to-Peer Network Environment

FIG. 3. illustrates one embodiment of a peer-to-peer network environment in which the present invention may operate. However, not all of these components may be required to practice the invention, and variations in the arrangement and type of the components may be made without deviating from the original scope or feeling of the invention.

As shown in the figure, system 300 includes peer nodes 302, 304, 308, 310 that act like servers, protecting and storing data and communicating with each other through the network or mobile network 306. Generally, peer nodes may include virtually any computing device capable of receiving and sending a message to and from another computing device, each other, or the like and that acts as servers for the storage of data, over a network or mobile network, such as network or mobile network 306. Peer node devices 302, 304, 308, 310 may include other applications that are configured to receive and to send web pages, web-based messages, and the like, configured to receive and display graphics, text, multimedia, and the like, employing virtually any web-based language, including but not limited to Standard Generalized Markup Language (SMGL), HyperText Markup Language (HTML), eXtensible Markup Language (XML), and so forth. The set of such peer node devices 302, 304, 308, 310 may include devices that typically connect to the internet through network or mobile network 306, using a wired or wireless communications medium such as mobile phones 302, laptops 304, tablets 310, personal computers 308, multiprocessor systems, microprocessor-based or programmable consumer electronics, network PCs, and the like. As shown in FIG. 3., process 300 illustrates one embodiment of the invention but is not so limited or restricted and may employ other elements not described herein. The invention is based on the claims hereinafter appended.

1. Confirming a user's sexual history.

2. After confirming a user's sexual history based in claim 1, users evaluate and assign grades to a user's performance of sexual interactions based on;
Flirting, Kissing, Foreplay, Oral Sex, Sexual Intercourse (including Anal Sex, Pegging and other Sexual Intercourse between LGBTQ users) and After, or the actions and behavior of a user post flirting, kissing, foreplay, oral sex or sexual intercourse occurs.

3. Ranking users based on any combination of geographical location and/or any part, total or average of the grades assigned in claim 2.

4. Providing scientific research, news and tips to improve the performance of sexual interactions via multi-medias, based on the results of the evaluations, grades and rankings in claim 2 and/or other scientific research.

5. Reporting a sex crime based on the results of the evaluations in claim 2 and scientific research from claim 4, if nonconsensual activities are alleged.

6. Sharing and embedding the results of the evaluations, grades and/or rankings in claim 2, on social medias, websites or mobile applications.

7. Setting a future time and place, giving consent or not for any part or whole of a date or sexual interaction, based on the results of the evaluations, grades and rankings in claim 2 and scientific research from claim 4.

8. Match-making or pairing users for a date or sexual interaction, based on the results of the evaluations, grades and rankings in claim 2 and scientific research from claim 4.

9. Geographically searching for and locating users for a date or sexual interaction, based on the results of the evaluations, grades and rankings in claim 2 and scientific research from claim 4.

10. Selling and purchasing merchandise that is customized based on the results of the evaluations, grades and rankings in claim 2 and scientific research from claim 4.
